(19) United States
(12) Patent Application Publication
(10) Pub. No.: US 2010/0090838 A1
(43) Pub. Date: Apr. 15, 2010

(54) Person recovery system and method

(76) Inventor: Steve Robinson, Lexington, KY (US)

Correspondence Address: STOCKWELL & SMEDLEY, PSC, 861 CORPORATE DRIVE, SUITE 200, LEXINGTON, KY, 40503, US

(21) Appl. No.: 12/287,589

(22) Filed: Oct. 10, 2008

(51) Int. Cl. G08B 23/00; G06F 17/00

(52) U.S. Cl. 340/573.4; 707/E17.001

(57) ABSTRACT

A system and method provides an electronic bracelet, necklace, clothing, shoes or tag for a person and maintains a database which correlates a variety of information with each such tag. When a person is reported lost or missing, pre-arranged volunteers are mobilized to begin searching for the person. Additionally, local media and other electronic means are utilized to quickly spread the alert that the person is lost. Once the lost person is found, the database of information can be utilized to ensure a quick and accurate identification of the person's care provider so that a successful return of the lost person can occur.

### BACKGROUND OF THE INVENTION

1. Field of the Invention

The present invention relates generally to personal safety and, more particularly with locating lost patients or persons.

2. Description of Related Art

Patients or persons with various forms of dementia or Alzheimer's disease may sometimes wander away from safe locations. Because of their condition, they may not recognize how to return to their safe locations and they may wander into unsafe situations.

Once a person is lost or has strayed, there is little a family member or care provider can do to try to find their ward. For example, they can search the general location where they think the person may be; they can enlist the help of others to cover more area; or they can contact the authorities to assist in the search.

From the general public's point of view, a wandering person is not necessarily recognized as a lost or missing person with Alzheimer's disease. Therefore, there are a number of instances where a helpful stranger might see a wandering person and could have helped the person but did not realize the person needed assistance.

Many care facilities have surveillance cameras and security procedures in place to limit the movement of patients with dementia but such measures are weighed against a person's basic freedoms and independence. Thus, even in the most effective facilities, patients may still wander away from a facility into an unsafe situation.

Thus, there remains an unmet need for a system and method that identifies persons as being lost, expands the people and resources available to a family members and care providers to help locate the lost person, alerts the public that the person is lost, and provides current information or database about the person so that once the lost person is found they can be returned to a safe location.

### BRIEF SUMMARY OF THE INVENTION

A system and method provides an electronic bracelet, necklace, clothing, shoes or tag for a person and maintains a database which correlates a variety of information with each such tag. When a person is reported lost or missing, pre-arranged volunteers are mobilized to begin searching for the person. Additionally, local media and other electronic means are utilized to quickly spread the alert that the person is lost. Once the lost person is found, the database of information can be utilized to ensure a quick and accurate identification of the person's care provider so that a successful return of the lost person can occur.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF DRAWINGS

Various aspects of embodiments of the present invention are illustrated by way of example, and not by way of limitation, in the accompanying drawings, wherein:

FIG. 1 illustrates a flowchart describing some of the foundational steps in establishing a system in accordance with the principles of the present invention;

FIG. 2 illustrates a flowchart of steps for locating a person in accordance with the principles of the present invention;

FIG. 3 illustrates a block diagram of a system and its users capable of implementing aspects of the present invention; and

FIG. 4 illustrates an exemplary volunteer kit in accordance with the principles of the present invention.

### DETAILED DESCRIPTION OF INVENTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

In the written description, herein, the term “person” will be used as well as in specific instances “patient”. It is not intended that the principles of the present invention be limited to only patients but that these principles are applicable to other persons as well. However, many of the problems of patients, especially those with some type of dementia, wandering or straying from a location where they are safe and cared for are particularly applicable to the principles of the present invention. Thus, in many instances herein the description will refer to the specific case of patients even if the general principles are applicable to other types of people as well. For example, watching and caring for children are examples of other activities that may benefit from embodiments of the present invention.

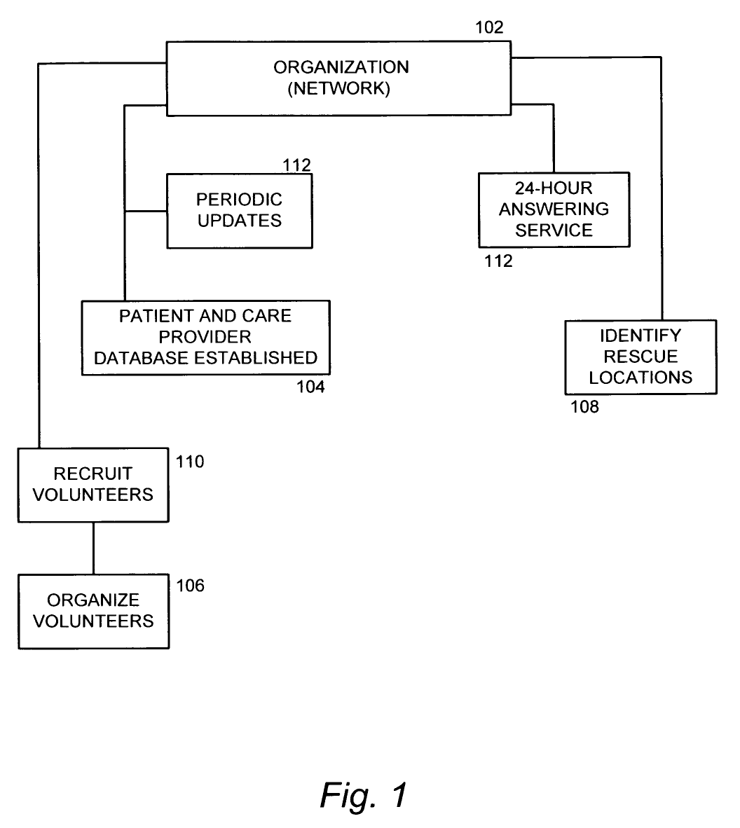

FIG. 1 illustrates a flowchart describing some of the foundational steps in establishing a system in accordance with the principles of the present invention. These steps would most effectively be performed by a single organization responsible for implementing the present system. For example, a hospital or care provider facility may be one example of an organization that would maintain such a system. Also, an independent organization may host the system for any local family member or care provider who wishes to participate. The system described herein could be provided for free and rely on the donations of individual, corporate and government entities. In the alternative, however, the system could be based on a fee which could be subscription based or a one-time fee.

The organization will, as shown in step 102, provide alert tags which have some type of identifier. The alert tags may be a tag that is placed on a bracelet or necklace or could be a bracelet or necklace with an integral tag. As used herein, the term “tag” is intended to encompass use of a bracelet, necklace, anklet, key fob, pendant, etc. which may be carried on a person's body relatively unobtrusively. As is known in the art, an RFID chip may be surgically implanted in the person as well but many people may find that option too intrusive an invasion of their privacy. The identifier, or serial number, of the tag is used to uniquely associate that tag with a specific person. One of ordinary skill will recognize that the identifier can simply be an indelibly printed number or could include an electronic component to add to its versatility. Other information, as discussed in detail below, may also be included on the tag. Additionally, the tag may be accompanied by a corresponding ID card or key-ring fob that a family member or care provider may retain. This ID card for the care provider is useful when attempting to return a found person to their care provider to ensure the person claiming the lost person is actually their proper care provider.

For example, the tag could include an RFID component that can be scanned from near (e.g., automobile) or far distances (e.g., helicopter). The RFID component may be active as well and radiate a signal even if not being actively scanned. In this latter arrangement, some type of replaceable power source (e.g., battery) or rechargeable power source (e.g., solar) would be provided as well. An even more elaborate tag is also contemplated that has a radio-frequency receiver such as, for example, a pager that can be activated remotely. In this way, a unique tag can be remotely activated in order to behave in a desired way. One exemplary behavior would be to turn on a light or beacon that will aid in visually identifying the person as being missing or lost. For example, if the person is reported lost and their tag's beacon is activated, then anyone seeing the wandering person would know that the person is lost and needs help. Furthermore, the lighted tag could be helpful in low-visibility situations to assist volunteers in locating the person.

For the alert tag to be useful in locating the person's care provider, a database is created in step 104 that provides a variety of details about the person and their care provider. Some exemplary information may include: the person's name, a current picture of the person, the person's favorite activities, eateries, locations, the care provider's name, the care provider's current contact information, a preferred doctor, an alternative contact person. Other information could be included as well that would help rescuers locate the lost person safely or to locate the care provider once the lost person is rescued.

In step 112, it is contemplated that the database of information will need to be periodically updated. Over time the appearance of the person may change as well as the contact information for the care provider (e.g., telephone number, e-mail address, address, etc); therefore keeping the information updated is beneficial for the operation of the present invention. While the updating of the database can be passive from the organization's view—they simply wait for the care providers to provide new information, it is better that the updating of the database be proactively handled by the organization. It is envisioned that the organization will send periodic e-mail reminders (e.g., every 3 months) to all registered participants asking them if any information has changed. The care provider may respond to the e-mail and need make no other special effort to ensure the database is updated. Advertisements or announcements may be included with these periodic reminders to generate business or interest in the organization and its partners. Other types of reminders such as mailings and telephone calls may be used as well to augment or to replace the e-mail reminders.

In addition to the organization creating and updating the database of information, the present invention also contemplates an online account creation and updating process that allow a care provider to easily create an account and to keep their information current.

Once the database of information is created, regardless of the manner, the organization may implement a readily available answering service (see step 112). While a 24-hour, 365-day service may be beneficial, an answering service where messages are periodically checked is also contemplated within the scope of the present invention. The database may be separated (either physically or logically) into two separate sections. One section includes personal information about the care provider that may not be safe to share with a wide population while the other section includes all the information about the person necessary to aid the volunteers in locating the person if they become lost. The answering service will have access to both sections of the database in order to confirm the authenticity of a call that is received regarding a lost person. For example, the database may include a pass-phrase or other authentication information with which the answering service can challenge a caller in order to verify their identity and to help avoid prank calls. When a call is received, the answering service accesses the other section of the database in order to collect the patient-related information needed to notify the volunteers, local media, other entities, and all the participants about the lost patient.

Another component of the present system is to recruit a team of volunteers willing to help in the search for lost people (see step 110). Rather than have to scramble to find volunteers once a person is reported missing, the team or teams can be prearranged so that any response is swift and organized. There are a number of ways to organize the volunteers, in step 106, without departing from the scope of the present invention. For example, teams can be organized so that every team is on-call for one week and then off for three weeks. There can be a tiered structure to the on-call status of a team so that if two people are missing concurrently, then the second team is selected according to a schedule as well. Teams can be categorized by geography as well. For example, a city or town may be broken into regions and each team is assigned a respective region for which they are always on-call.

While the number of individuals for each team of volunteers is not critical, it is preferably a number that is sufficient to provide meaningful help during a search but small enough that it is manageable and so that the team can fit in a minimum number of vehicles to transport them to the search site.

Alternatively to organizing the volunteers as teams, they can be organized as simply a rotating roster so that for each rescue operation the next 4 (or 5, or 6) names on the roster are called. Regardless of how the volunteers are organized, their contact information is maintained in a database so that they can be easily mobilized. For example, an alert message may be sent automatically via a telephone, a text message, and e-mail so this type of information about the volunteers is maintained. Also, a phone-tree arrangement can be made so that contacting the volunteers becomes a distributed endeavor. Because the database holding the patient information has pictures, the alert message sent to volunteers can include pictures of the person and other pertinent information.

One other helpful component of the present system is to identify safe locations where someone is to return a missing person. The organization maintaining the system may or may not have the facilities for caring for a found person until they can be returned to their care provider. However, additional partners can volunteer to be safe locations as well such as hospitals, urgent care clinics, and fire stations. The public, if they found a lost patient, would know they could take the person to one of these safe locations at any time and rescue volunteers could drop off a rescued person at any of the safe locations as well. Eventually the organization maintaining the database of care provider/patient information would be contacted so that the patient could be returned to the care provider. To help the public know where these safe locations are, the alert tag can include information such as “This is a registered patient, please call or take to Organization X.”

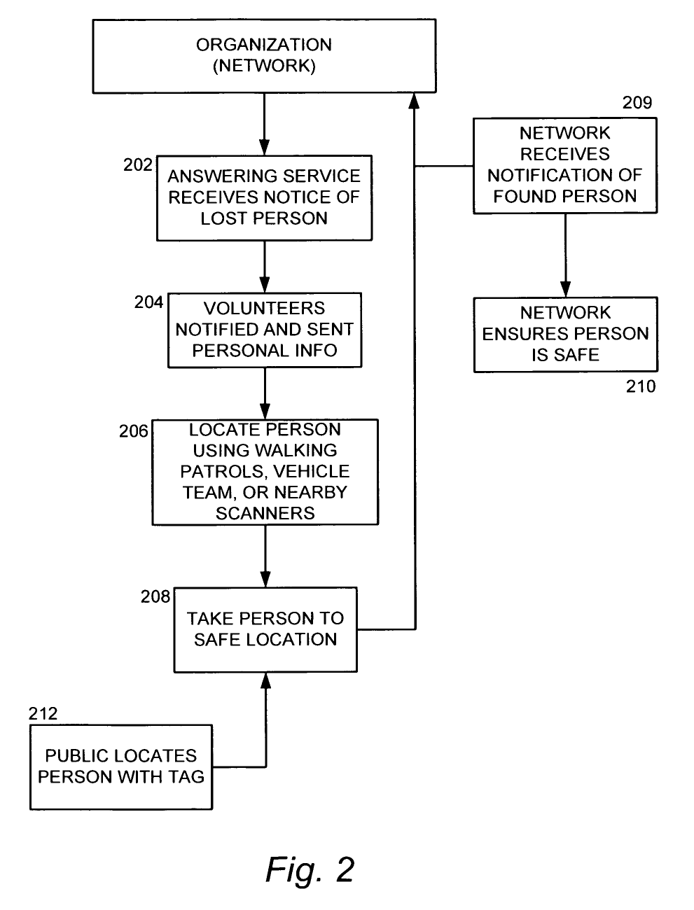

FIG. 2 illustrates a flowchart of steps for locating a person in accordance with the principles of the present invention. Once a care provider who has registered a patient or person with the present system realizes their ward is lost, they would notify the organization by contacting the answering service, in step 202. Based on the care provider's information, the organization can identify the person and their associated alert tag ID number. In step 204, the organization notifies the volunteers that a person is lost along with the location where the care provider last believes the person to have been. The notification of the volunteers can include information from the database such as a current picture of the person, a written description of their physical appearance, and their name. As mentioned above, the contact with volunteers can be through any of a variety of available ways.

In addition to the volunteers, the present system also contemplates the participation of the local media and other entities within the locale. For example, an alert message may be sent to the television and radio media so that a bulletin can be broadcast. This bulletin, at least for visual media, can include a picture of the person and most of the same information that is shared with the volunteers as discussed above.

The present invention also contemplates a web-based aspect that can have a page dedicated to ongoing searches. Another way to spread messages is via highway signs, electronic billboards or the like and transportation and other government officials may need to be involved.

Web-based kiosks are also a useful way to notify the public of a lost person. For example, a grocery store or other store may sponsor a kiosk that has a visual screen. The screen can typically be used to display advertisements, specials, or other information. However, when there is a lost-patient alert nearby to that kiosk, the screen will display the person's picture and other information so that the general public may help with locating the missing person. With the advent of digital picture frames, the kiosk need not be a large, bulky kiosk but can also encompass a relatively small, flat system that is configurable to hang on a wall or attach to a flat surface.

In step 206, the volunteer team is mobilized and locates the person using any of a number of resources. In one embodiment, the team is provided with a sponsored vehicle that is equipped with equipment helpful for locating a lost person. Using the vehicle, the team can be transported to a location with some team members performing a walking patrol and other team members performing a driving patrol. One particularly useful tool is an RFID scanner that can be used to locate the lost person. The scanner will indicate the presence of one of the registered alert tags. A more elaborate scanner may be used to search only for the lost person's ID tag so that the scanner would indicate not just the presence of an alert tag but also the identifying number for that alert tag.

It is also possible that the missing person is located, in step 212, by a member of the public that may or may not be aware that the alert notice has been activated. Regardless of whether or not a volunteer or a member of the public find the missing person, they would return him to a safe location, in step 208. From there, the organization is notified of the found person, in step 209, so that the care provider can be identified and the person returned to a safe location, in step 210.

Once a person is rescued, the system and methods used for broadcasting the alert can similarly notify that the alert can be cancelled.

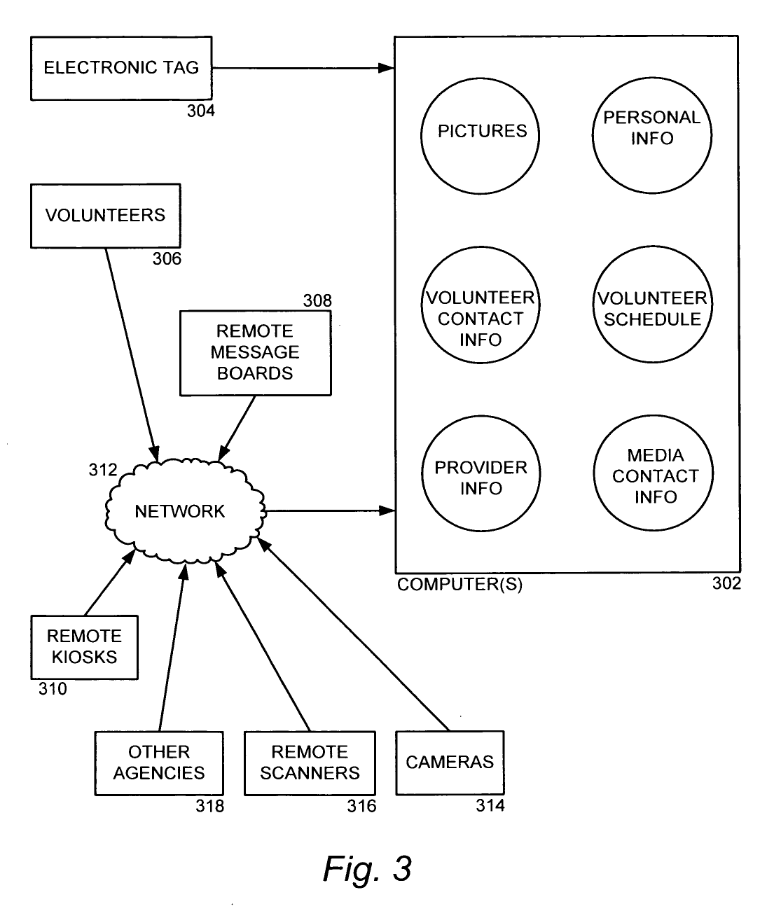

FIG. 3 illustrates a block diagram of a system and its users capable of implementing aspects of the present invention. The elements within FIG. 3 are many of the same elements that have already been discussed. They include the alert tag 304 that is used to create a number of the databases maintained by the organization's computers 302. Information about contacting the media, contacting volunteers, and contacting care providers is all provided along with information about each person or patient associated with each of the alert tags 304. In FIG. 3, the various information stored by the computer 302 is depicted as a number of separate databases; however, one of ordinary skill will recognize there are a number of functionally equivalent ways to store this information without departing from the scope of the present invention. One or more of the databases can be combined and can even be stored on separate computers in communication with one another.

Many of the elements connected through the network 312 help in alerting the volunteers 306 as well as the general public about a missing person. For example, remote kiosks 310, message boards 308 (e.g., traffic boards, billboards, etc.), and other agencies and the media 318 are all outlets for quickly alerting the public about a lost person.

An additional resource not yet discussed are the cameras 314 and remote scanners 316. Scanners 316 capable of identifying the presence of an RFID tag can be spread throughout a city and attached to telephone poles, lamp posts, or street signs. When a scanner identifies the presence of an RFID alert tag it can send a message to the organization's computer 302. This message may be through a network cable, a wireless network connection, or a radio-frequency transmitter. The computer 302 can include an artificial intelligence component that can deduce whether it is unlikely that the particular person with that alert tag would be in the vicinity of the scanner that sent the message. If the person is unlikely to be in that area, then an e-mail or telephone call can be placed to the care provider to see if their patient is missing.

Alternatively, the scanners 316 may simply record RFID alert tag numbers along with a time stamp. If a person is reported missing, then the scanner records can be searched to see if the general location of the person can be narrowed. As another alternative the scanners 316 may not always be powered on but, instead are activated once a missing person alert is announced. From that time on the scanners 316 can monitor and report any signals that appear to be from the missing person's alert tag. The cameras 314 may work in conjunction with the scanners 316 so that a camera or cameras near a scanner that identifies a missing person may be activated and capture a visual image of the area that might assist in locating the missing person. If there is a location that has proven attractive to wandering persons of the type missing (e.g., child, elderly patient, etc.), then cameras could be placed there and always activated and monitored.

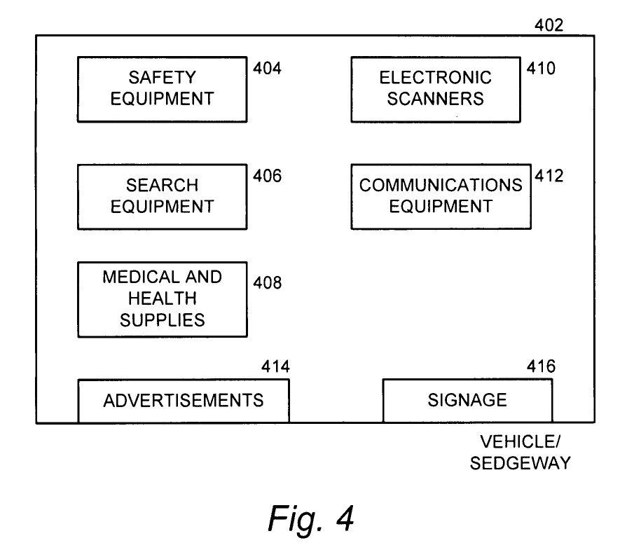

FIG. 4 illustrates an exemplary volunteer kit in accordance with the principles of the present invention. Equipping the volunteers with the equipment they need will provide even a greater assurance that locating the missing person will be quickly accomplished. Preferably, the volunteer team is provided a sponsored vehicle (or possibly a team member is outfitted with a Sedgeway) 402 that can include sponsor's and others' advertisements 414 along with signage 416 that identifies the vehicle 402 as belonging to volunteers looking for lost persons.

Safety equipment 404 can include reflective vests, rain gear, flares, traffic cones and other items that help protect the safety of the volunteers. Search equipment 406 can include a vehicle-based microphone, flashlights, spot lights, binoculars, night-vision goggles and similar items to help in the search for the missing person. One piece of equipment that is particularly useful is one or more electronic handheld RFID scanners 410 that can be used by a walking patrol or a driving patrol to scan for nearby alert tags. If tags other than RFID tags are used, then the scanner 410 would be appropriate for locating that type of tag. Other useful equipment can include health or medical related equipment 408 along with food and water equipment and communications equipment 412 so that the volunteer team and the organization can be in contact with each other at all times

As described above, embodiments of the present invention contemplate a network of RFID scanners, or other similar future technology, that will aid in the detection of a lost people within a geographic area. One method for locating such scanners is to simply space them evenly across a grid or other geometric shape. However, the placement and spacing of the scanner network may also be organized differently as well. For example, an industrial park will likely have fewer lost people than an area around family neighborhoods or an area around a care facility. Thus, the scanner network may be arranged to consider the number and density of people, the number and density of care facilities, the number of roads, the number and proximity of parks and playgrounds, and the number of businesses or density of office space.

Even though the scanner network has been described with relation to locating lost patients, once it is in place the network may be used for additional purposes as well. For example, if a child is provided with an RFID tag that has an allowable boundary defined for that child, then the network can detect if the child wanders outside that boundary. Neighborhood associations may also use the network to monitor the activities of individuals visiting the neighborhood. For example, if a contractor or repairman were provided with an RFID tag upon entering a community, then the location and route of that person could be tracked and monitored. The network can be arranged so as to provide a perimeter around a playground or similar area so that if certain RFID tags (e.g., children) ever leave the perimeter, then an alarm will activate. One of ordinary skill will recognize that the scanner network described herein can be used for a number of additional purposes separate from locating a lost patient.

While it is contemplated that the database of information may be useful in many situations other than locating a missing person, one particular use is that of aiding emergency response efforts after a natural or man-made disaster. Care providers or family members who register their patients with the system can know that rescue personnel will know which houses or facilities are likely to contain patients when making rescues. Also, after the emergency, if wandering patients or people are found, emergency personnel or shelter coordinators will have a way of contacting the care providers so that the patients can be reunited.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for rescuing a missing person, comprising the steps of:
maintaining a first database of information about each of a plurality of persons, including associating with each respective person a unique tag identifier;
maintaining a second database of volunteers who agree to help locate missing persons; and
implementing an alert message system configured to send an alert message to at least some of the volunteers in response to receiving notification about the missing person; and
implementing a care provider contact system configured to identify the missing person's care provider based on the first database.

2. The method of claim 1, further comprising the step of:
designating one or more return locations to receive missing persons.

3. The method of claim 1, wherein the alert message system is further configured to send an announcement message to at least one of a television and a radio media outlet.

4. The method of claim 1, wherein the alert message system is further configured to send an announcement message to at least one of a remote scanner, a remote kiosk, a remote message board.

5. The method of claim 1, further comprising:
providing each respective person with a tag including its unique tag identifier.

6. The method of claim 5, wherein each of the respective tags includes an RFID tag corresponding to its unique tag identifier.

7. The method of claim 1, wherein the first database includes a picture of each respective person.

8. The method of claim 1, further comprising:
implementing an update system configured to periodically send a message requesting updated information and to update the first database based on a received response.

9. A system for rescuing a missing person, comprising:
a first database configured to maintain information about each respective person including a unique tag identifier associated with each person;
a second database configured to maintain information about volunteers who agree to help locate missing persons;
an alert system, in communication with the first and second databases, configured to receive notification of a missing person and send an alert message to at least some of the volunteers; and
a care provider notification system, in communication with the first database, configured to identify and contact a care provider of a respective person.

10. The system of claim 9, further comprising:
a plurality of tags each including one of the unique identifiers.

11. The system of claim 10, wherein each of the plurality of tags includes an RFID tag corresponding to its unique identifier.

12. The system of claim 10, wherein each tag includes an identification of at least one return location where to return the missing person.

13. The system of claim 9, wherein the alert message includes a picture of the missing person.

14. The system of claim 9, further comprising:
an announcement system configured to send a message to at least one of: a media outlet, a remote kiosk, a remote website, a remote message board, and a remote scanner.

15. The system of claim 14, wherein the message includes an image of the missing person.

16. The system of claim 9, wherein information about each respective person includes an image of that person.

17. The system of claim 9, wherein information about each respective person includes: emotional disposition, physical description, and care provider contact information.

18. The system of claim 9, further comprising:
a volunteer equipment pack that includes one or more of: a vehicle, safety equipment; search equipment, communications equipment, and at least one RFID scanner.

19. A method for rescuing a missing person, comprising the steps of:
associating a respective unique tag with each of a plurality of persons;
sending a first message to a predetermined set of volunteers informing the volunteers when one of the persons is missing;
receiving a person having one of the respective unique tags, that is believed to be missing;
identifying the person based on its respective unique tag; and
contacting an care provider of the person based on care provider information associated with the unique tag.

20. The method of claim 19, further comprising:
sending a second message, when one of the persons is missing, to at least one of: a media outlet, a remote kiosk, a remote message board, a website.
